(19) United States
(12) Patent Application Publication
(10) Pub. No.: US 2015/0361306 A1
(43) Pub. Date: Dec. 17, 2015

(54) Articles and Methods for Efficient Application of Paint To and Removal of Paint From a Surface

(71) Applicant: entrotech, inc., Columbus, OH (US)

(72) Inventor: James E. McGuire, JR., Westerville, OH (US)

(21) Appl. No.: 14/307,127

(22) Filed: Jun. 17, 2014

(51) Int. Cl. C09J 7/02; B32B 7/12; B32B 38/08; B32B 43/00; B32B 37/12

(52) U.S. Cl. CPC C09J 7/0264; B32B 43/006; B32B 37/12; B32B 38/08; B32B 7/12; B32B 2398/00; B32B 2605/18; C09J 2203/306; B32B 2605/00

(57) ABSTRACT

Paint film of the invention of the invention comprises: at least one adhesive layer; at least one polymer layer adjacent a portion of the at least one adhesive layer; and a non-adhering gripping portion along at least one edge of the paint film. Paint film can be shaped to facilitate wrapping thereof around an object so that the gripping portion is positioned on a first side of the object opposite to a second side of the object to which adherence of the paint film is desired.

### BACKGROUND OF THE INVENTION

The present invention relates generally to articles and methods for efficient application of paint to and removal of paint from a surface.

Painted surfaces are commonly used in many different types of applications. Painted surfaces can not only improve aesthetic properties of a surface, but they can also improve functional properties of underlying surfaces and help protect the same. One such application is in the transportation industry, where exterior painted surfaces are typically exposed to a variety of environments, some of which can be very harsh on the surface. Examples of articles in the transportation industry having such painted surfaces include vehicles providing transportation over land, in the water, and in the air. Such vehicles include aircraft and motorized vehicles like automobiles and trucks. The paint on such surfaces can function to protect the underlying surface from damage due to that exposure. However, the paint itself must also be durable to withstand repeated exposure to such damaging environments.

Painting exterior surfaces on vehicles poses many challenges, not only due to the amount of surface area typically requiring painting and the often uneven topography of such surfaces, but also due to increasingly stringent environmental regulations. For example, there is a desire for and increasingly regulations requiring a reduction in Volatile Organic Component (VOC) emissions, particularly in industries utilizing significant amounts of paint and other organic chemicals. VOC emission reduction and water conservation, both associated with conventional liquid-applied painting processes, are therefore increasingly important environmental considerations.

A further consideration associated with painting or otherwise covering exterior surfaces on aircraft and similar vehicles is the impact of the relatively high vehicle speeds on the surface of the vehicle and any coatings or coverings thereon. For example, wind resistance associated with travel at high speeds can make it difficult to retain uniform and adequate adherence of such coatings or coverings on a vehicle's surface. Thus, coatings and coverings developed for application to exterior surfaces of vehicles traveling on, for example, land are often not adequate to withstand the challenging conditions associated with higher speeds of travel through air.

To overcome many of the challenges associated with painting exterior surfaces of vehicles using conventional methodology, a number of paint replacement technologies have been developed so that use of liquid-applied paint can be minimized or avoided. For example, technology directed toward replacement of liquid-applied paint includes adherence of a paint replacement film or sheet to a surface. One such paint film is described in U.S. Patent Publication No. US-2010-0059167-A1.

Despite the number of paint replacement technologies, conventional technology has not satisfactorily addressed paint replacement in all situations, particularly applications involving vehicles used for air transportation. Not only are adequate adhesion and durability issues for painted exterior surfaces on such vehicles, but it is also desirable to be able to remove and/or replace the paint easily when desired. In the case of an aircraft, for example, company logos and designs often change, which leads to a desire to refinish aircraft displaying outdated logos and designs. This is particularly prevalent in the case of leased aircraft, which often undergo multiple and repeated changes of possession and, thus, changes in associated individual or company logos and designs.

Even when the process for removal of paint from a surface does not require sanding, which requirement for sanding is typically the case with respect to liquid-applied paint, removal of paint from a surface can also be potentially problematic. When the underlying surface is a composite material, for example, damage to (e.g., breakage of) the composite's reinforcement material (especially when that reinforcement material comprises fibers) can negatively affect not only aesthetics of the surface, but also its structural properties. Fibers positioned adjacent an exterior surface of fiber-reinforced composite materials are known to often comprise a significant portion of the load-bearing capacity of the material. Removal of paint from surfaces comprising composite material is, thus, a particularly sensitive process in that damage to fibers on that surface can compromise structural integrity and performance of the material. Thus, extreme care and time must often be taken when removing paint from surfaces comprising composite material. As another example of potential problems associated with removal of paint from a surface, many conventional paint films are known to internally delaminate and leave adhesive residue on a surface. Further, the process of initiating removal of conventional paint film can be complicated when edges of the film are difficult to locate and/or detach from a surface.

Not only must time for removal of paint present on a surface be considered when refinishing a surface, but time for application of paint to a surface must also be considered when optimizing efficiency of paint replacement technology. When applying a paint film to a surface, for example, a paint film is conventionally adhered to a surface as a continuous film and then selectively removed so that the paint film covers only those portions of the surface desired. For example, when paint film is adhered to a fuselage of an aircraft, windows and other features on the fuselage often must have paint film selectively removed therefrom. The processing of selectively removing the paint film conventionally includes cutting the paint film along edges of those portions of the surface from which removal of the paint film is desired and then removing the cut-out portions of the paint film from the surface. Not only does this conventional process result in significant material waste, but it takes time and can damage the underlying surface when not performed carefully. The process of forming the cut-outs can be time-consuming, especially in the case of surfaces containing a large number of features from which the paint film must be removed after its adherence to the surface as a continuous film. Further, tools used to selectively cut the paint film can mar or otherwise damage underlying surfaces. When the underlying surface is a composite material, for example, damage to (e.g., breakage of) the composite's reinforcement material (especially when that reinforcement material comprises fibers) can negatively affect not only aesthetics of the surface, but also its structural properties. Thus, alternative processes for application of paint in film to a surface are desirable.

As noted, a number of problems are inadequately addressed by conventional paint replacement technologies. While paint in film form overcomes many problems associated with liquid-applied paint technology, alternative and improved articles and methods for application of paint film are desired.

### BRIEF SUMMARY OF THE INVENTION

Paint film of the invention comprises: at least one adhesive layer; at least one polymer layer adjacent a portion of the at least one adhesive layer; and a non-adhering gripping portion along at least one edge of the paint film. In one embodiment, the adhesive layer comprises a pressure-sensitive adhesive. In a preferred embodiment, the gripping portion comprises an uninterrupted extension of the polymer layer of the paint film, but without the adhesive layer adjacent thereto. In one embodiment, width of the gripping portion is at least about 1.3 centimeters (0.5 inch).

The paint film can be shaped to facilitate wrapping of the paint film around an object so that the gripping portion is positioned on a first side of the object opposite to a second side of the object to which adherence of the paint film is desired. In one embodiment, the paint film comprises at least one cut-out positioned therein and corresponding to a feature on a surface of an object to which adherence of the paint film is generally desired.

When paint films are wrapped therearound, objects of the invention comprise a surface on which the paint film is adhered to at least a portion thereof. The surface comprises a fiber-reinforced composite material in one embodiment.

According to one aspect of the invention, the gripping portion of the paint film is positioned on a side of the object that is not outwardly exposed. In contrast, according to further embodiments, objects of the invention comprise a clearcoat on at least a portion of an outwardly exposed surface of the object.

In one embodiment, the object comprises a motorized vehicle. In another embodiment, the object comprises a fuselage of an aircraft. In a further embodiment, the object comprises an access panel on an aircraft fuselage.

A method of applying paint to a surface according to the invention comprises: adhering the paint film to at least a portion of at least one exterior surface of an object, wherein the gripping portion of the paint film is positioned on a side of the object that is not outwardly exposed; and applying a clearcoat to essentially the entire outwardly exposed surface of the object, except for those portions of the outwardly exposed surface where the clearcoat would detract from function of an underlying feature on the object. A method of removing paint from a surface on an object comprises: providing the object; and grasping the gripping portion of the paint film to peel the paint film from the surface.

### BRIEF DESCRIPTION OF THE SEVERAL VIEWS OF THE DRAWINGS

FIG. 1A is a perspective view of one embodiment of a paint film of the invention, wherein the paint film is shaped for adherence to an access panel on an aircraft fuselage.

FIG. 1B is a rear view of the access panel of FIG. 1A, wherein the paint film is adhered thereto with a gripping portion positioned on an interior surface of the access panel.

### DETAILED DESCRIPTION OF THE PREFERRED EMBODIMENTS OF THE INVENTION

Articles and methods of the invention are generally directed toward paint in film form. The phrase “paint in film form” (also referred to as “paint replacement film” and/or “paint film”) encompasses films including essentially one uniform color throughout as well as films which, by themselves or in combination with other paint films, include graphics, patterns, and other non-uniformly dispersed color variations throughout. Paint films of the invention generally include a polymer layer and an adhesive layer. In exemplary embodiment, paint films also include a pigmented layer disposed between the polymer layer and the adhesive layer and/or a pigmented layer disposed on an exterior surface of the polymer layer. The pigmented layer can provide the desired uniform or non-uniform color throughout the film. The adhesive layer facilitates adherence of the paint film to a desired surface. For ease of repositionable application of the paint film to a surface as well as removability from the surface when desired, preferably the adhesive layer comprises a pressure-sensitive adhesive.

Paint in film form provides many advantages as compared to liquid-applied paint. An exemplary paint film and associated advantages is described in U.S. Patent Publication No. US-2010-0059167-A1, incorporated herein by reference in its entirety.

Each of the layers within paint films of the invention comprises any suitable thickness. In one embodiment, the adhesive layer has a thickness of about 5 microns to about 150 microns. In a further embodiment, the adhesive layer has a thickness of about 30 microns to about 100 microns. In an exemplary embodiment, the adhesive layer is about 25 microns thick or less. In one embodiment, the polymer layer has a thickness of about 10 microns to about 50 microns. In an exemplary embodiment, the polymer layer is about 25 microns thick or less. It has been found that use of a relatively thin polymer layer contributes to superior flexibility of the paint replacement film. Such flexibility allows paint films of the invention to be effectively used in covering articles (e.g., aircraft) having curved or other non-planar surfaces.

Paint film according to the invention includes a gripping portion on at least a portion of its perimeter (i.e., along at least one edge of the paint film). The “gripping portion” is generally free of adhesive or other material that would otherwise facilitate adherence of the gripping portion to a surface on which adherence of the paint film is generally desired. Advantageously, to facilitate ease of removal of the paint film from a surface when desired, the non-adhering gripping portion is provided along at least one edge of the paint film adhered to the surface.

Preferably, the paint film is shaped to facilitate wrapping of the paint film around the object so that the gripping portion is positioned on a side of the object other than that to which adherence of the paint film is desired. Preferably, the gripping portion is positioned on a side of the object that is not outwardly exposed. Generally, “outwardly exposed” refers to positioning with exposure to elements such as wind, waves, abrasive particles, and the like in the environment in which the object, or larger article of which it is a part, is intended to be used. For example, in the case of an aircraft, the gripping portion is preferably positioned so that it is not exposed on the exterior of the aircraft during flight. In that manner, risk of inadequate adherence of the paint film due to exposure of the gripping portion to challenging conditions associated with higher speeds of travel through air is eliminated. An interior surface on the aircraft, even though it might be visible from within the aircraft, is not generally considered outwardly exposed.

The gripping portion can be made from the same or different materials as those materials used elsewhere in the paint film. In one embodiment, the gripping portion comprises a rigid tab such as that described in U.S. Patent Publication No. US-2012-0255562-A1, incorporated herein by reference in its entirety. Preferably, however, for efficiency, the gripping portion comprises an uninterrupted extension of the polymer layer of the paint film, but without the adhesive layer adjacent thereto.

Dimensions of the gripping portion can vary according to, for example, dimensions and nature of the surface to which the paint film is intended to be adhered. In an exemplary embodiment, the gripping portion extends at least about 1.3 centimeters (0.5 inch) past the adhesive layer in the paint film so that width of the gripping portion is at least about 1.3 centimeters (0.5 inch). In another exemplary embodiment, the gripping portion extends about 1.3 centimeters (0.5 inch) to about 2.6 centimeters (1.0 inch) past the adhesive layer in the paint film. The width of the gripping portion need not be the same along the perimeter of the paint film and can vary along the perimeter.

Preferably, a paint film according to the invention is shaped so that it includes at least one cut-out positioned therein and corresponding to a feature on the surface over which adherence of the paint film is not desirable. The type and number of such features on a surface is unlimited. Preferably, the shape of the cut-out is approximately the same shape as the feature. However, it is to be understood that a tolerance can be factored into the shape.

In one embodiment, at least one cut-out corresponding to a mechanical fastener on the surface is positioned on a paint film. When the mechanical fastener is a countersunk screw, for example, the cut-out may have a tolerance of up to, for example, about 3.175 millimeters (0.125 inch) from the screw hole.

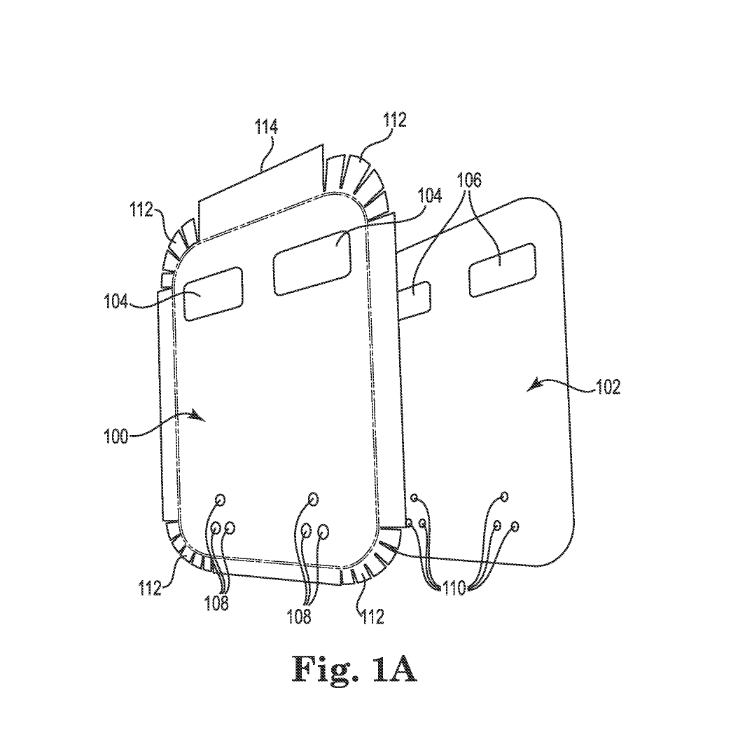

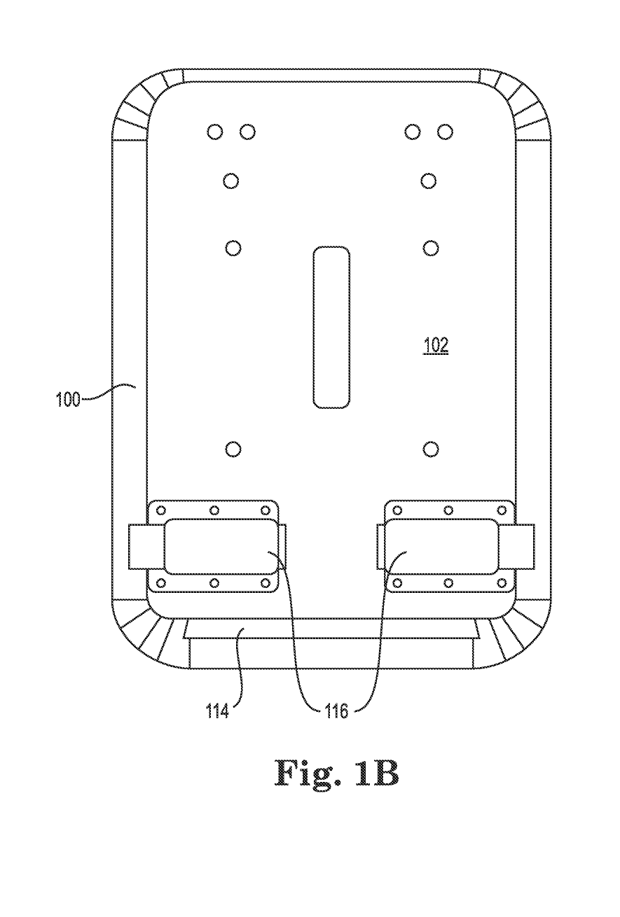

In an exemplary embodiment, as illustrated in FIG. 1A, a paint film 100 is shaped to facilitate wrapping around an access panel 102 of an aircraft fuselage. The paint film 100 comprises cut-outs 104 corresponding to openings 106 for handles 116 on the access panel 102, the back side of which is illustrated in FIG. 1B. The paint film 100 also comprises cut-outs 108 corresponding to screws 110 on the access panel 102. Optionally, the paint film 100 may also comprise cut-outs or slits 112 to facilitate wrapping of the paint film 100 around the access panel 102. The paint film 100 comprises a gripping portion 114 comprising an uninterrupted extension of the polymer layer of the paint film 100, but without the adhesive layer adjacent thereto. When applied to an access panel 102 of an aircraft fuselage, as illustrated in FIG. 1B, the gripping portion 114 of the paint film 100 is positioned on an interior surface of the access panel 102.

Until the paint film is adhered to a surface, it can be stored with an optional release liner adjacent the adhesive layer and with an optional carrier on the opposite side thereof. The selection and use of such carriers and liners is within the knowledge of one of ordinary skill in the art. When applied, paint films can cover substantially all of or select portions of exterior surfaces on a variety of articles, such as transportation vehicles. The paint film can be applied to a surface according to principles and methodologies understood by those of ordinary skill in the art. For example, the release liner, if present, is first removed. Then, the surface to which the paint film is to be adhered can optionally be sprayed with a cleaning and/or anti-slip agent (e.g., a mixture of 3 parts water to 1 part isopropanol). The adhesive layer of the paint film may also be sprayed with such an agent. Still further, once the paint film is positioned over the surface to which it is to be applied, the film may also be sprayed with such an agent. Thereafter, the paint film is firmly adhered to the underlying surface using, for example, a squeegee. Excess cleaning and/or anti-slip agent is then removed from the surface and the film is allowed to set for a time sufficient to prevent inadvertent removal of the film upon removal of any carrier used in conjunction therewith. The carrier, if present, is then removed.

According to a preferred embodiment of the invention, a clearcoat is applied to the exterior surface of the paint film on a side opposite the adhesive. In this embodiment, the clearcoat overlays the paint film to form a composite article. In one embodiment, a clearcoat is applied (e.g., by spraying or painting it) on the paint film after adherence of the paint film to an underlying surface. Preferably, the clearcoat is applied such that no paint film is exposed to the outwardly exposed environment when the composite article is adhered to a surface for use. Still further, when more than one paint film is used in combination with others on a surface, the clearcoat preferably covers and protects seams between adjacent paint films from exposure to the environment.

The clearcoat is applied on the exterior surface of the paint film to a desired thickness according to coating methodology known to those skilled in the art. In an exemplary embodiment, the total dry thickness of the applied clearcoat is about 10 microns to about 60 microns, preferably about 20 microns to about 40 microns. Depending on the desired thickness, the clearcoat can be applied in one or more coating layers. For example, two individual coating layers comprise the clearcoat according to one embodiment. In this embodiment, each coating layer is sprayed wet, but not so wet as to flow unevenly across the surface and create a significantly non-uniform clearcoat. If desired, the outer layer of the paint film is primed with a cleaning agent (e.g., a mixture of 3 parts water to 1 part isopropanol) to remove any contamination before the optional clearcoat is applied.

Recognize that, when used, the clearcoat may be applied over a discrete portion of the paint film adhered to a surface. It is preferred, however, that the clearcoat is applied to encapsulate essentially all of the paint film. When applied to an aircraft, for example, it is particularly preferred to apply the clearcoat to essentially the entire exposed surface of the aircraft, except for those surfaces where the clearcoat would detract from the function of the underlying surface (e.g., as in the case of windows or other features positioned at cut-outs in the paint film, which may be taped or otherwise covered during application of the clearcoat to prevent coating thereof).

Paint films of the invention are useful for application to a wide variety of exterior surfaces. For example, such paint films find particularly beneficial use when adhered to exterior surfaces of many transportation vehicles. In an exemplary embodiment, paint films of the invention are effectively and durably adhered to the exterior surface of an airborne transportation vehicle, which vehicles are typically subject to extreme wind resistance and other challenging environmental conditions when in use. For example, the paint films are capable of being effectively and durably adhered to the exterior surface of an aircraft.

The paint films are also capable of being efficiently removed from surfaces (e.g., surfaces of an aircraft) when needed. To remove paint films of the invention from a surface, grasping and pulling of the gripping portion of the paint film to gradually peel the paint film from the surface is generally all that is needed. Thus, removal of paint films according to the invention is significantly more efficient than conventional processes for removal of paint from a surface. Further, paint films of the invention can be efficiently removed from surfaces comprising a composite material (e.g., fiber-reinforced composite material) without significantly compromising structural integrity or performance properties of the material.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language. Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention. Finally, any material or performance properties described or measured herein are those existing at room temperature and atmospheric pressure unless specified otherwise.

1. A paint film comprising:
at least one adhesive layer;
at least one polymer layer adjacent a portion of the at least one adhesive layer; and
a non-adhering gripping portion along at least one edge of the paint film.

2. The paint film of claim 1, wherein the paint film is shaped to facilitate wrapping of the paint film around an object so that the gripping portion is positioned on a first side of the object opposite to a second side of the object to which adherence of the paint film is desired.

3. The paint film of claim 1, wherein the gripping portion comprises an uninterrupted extension of the polymer layer of the paint film, but without the adhesive layer adjacent thereto.

4. The paint film of claim 1, wherein width of the gripping portion is at least about 1.3 centimeters (0.5 inch).

5. The paint film of claim 1, wherein the paint film comprises at least one cut-out positioned therein and corresponding to a feature on a surface of an object to which adherence of the paint film is generally desired.

6. The paint film of claim 1, wherein the adhesive layer comprises a pressure-sensitive adhesive.

7. An object comprising a surface on which the paint film of claim 1 is adhered to at least a portion thereof.

8. The object of claim 7, wherein the object comprises a motorized vehicle.

9. The object of claim 7, wherein the object comprises a fuselage of an aircraft.

10. The object of claim 7, wherein the object comprises an access panel on an aircraft fuselage.

11. The object of claim 7, wherein the gripping portion of the paint film is positioned on a side of the object that is not outwardly exposed.

12. The object of claim 7, further comprising a clearcoat on at least a portion of an outwardly exposed surface of the object.

13. The object of claim 7, wherein the surface comprises a fiber-reinforced composite material.

14. A method of applying paint to a surface, the method comprising:
adhering the paint film of claim 1 to at least a portion of at least one exterior surface of an object, wherein the gripping portion of the paint film is positioned on a side of the object that is not outwardly exposed; and
applying a clearcoat to essentially the entire outwardly exposed surface of the object, except for those portions of the outwardly exposed surface where the clearcoat would detract from function of an underlying feature on the object.

15. The method of claim 14, wherein the object comprises a motorized vehicle.

16. The method of claim 14, wherein the object comprises a fuselage of an aircraft.

17. The method of claim 14, wherein the object comprises an access panel on an aircraft fuselage and the gripping portion of the paint film is positioned on an interior of the access panel.

18. A method of removing paint from a surface on an object, the method comprising:
providing the object of claim 7; and
grasping the gripping portion of the paint film to peel the paint film from the surface.
